(19) United States
(12) Patent Application Publication
(10) Pub. No.: US 2010/0010965 A1
(43) Pub. Date: Jan. 14, 2010

(54) Query Management Systems

(75) Inventors: Stefan B. Edlund, San Jose, CA (US); Joshua W. Hui, San Jose, CA (US)

Correspondence Address: KALI LAW GROUP, P.C., P.O. BOX 60187, SUNNYVALE, CA, 94088-0187, US

(73) Assignee: INTERNATIONAL BUSINESS MACHINES CORPORATION, Armonk, NY (US)

(21) Appl. No.: 12/169,531

(22) Filed: Jul. 8, 2008

(51) Int. Cl. G06F 17/30

(52) U.S. Cl. 707/3; 707/E17.014

(57) ABSTRACT

Methods and computer program products are presented for managing a query result set in response to a search, including: generating a user request corresponding with a portion of the query result set, responsive to the portion of the query result set being resident on a client cache, returning the portion of the query result set corresponding with the user request to a client table, responsive to the user request not having been sent to an application server, adding the user request to an inflight queue, sending the user request to the application server, returning the portion of the query result set corresponding with the user request to the client cache, and returning the portion of the query result set corresponding with the user request to the client table, and responsive to the user request having been sent to the application server, adding the user request to a blocked cache queue.

### FIELD OF INVENTION

The present invention relates generally to managing large query result sets corresponding with a search.

### BACKGROUND

When a user initiates a search, as for example, when using a web search engine, a set of results corresponding with a user query may be returned. Increasingly, online web searching tends to return large query result sets consisting of numerous results. A user navigating large query result sets may, in some examples, increase demands on network resources. Managing large query result sets, therefore, becomes increasingly important in order to provide more effective network services deployment.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Methods and computer program products are presented for managing a query result set in response to a search, including: generating a user request corresponding with a portion of the query result set, responsive to the portion of the query result set being resident on a client cache, returning the portion of the query result set corresponding with the user request to a client table, responsive to the user request not having been sent to an application server, adding the user request to an inflight queue, sending the user request to the application server, returning the portion of the query result set corresponding with the user request to the client cache, and returning the portion of the query result set corresponding with the user request to the client table, and responsive to the user request having been sent to the application server, adding the user request to a blocked cache queue.

In other embodiments, systems for managing a query result set are presented including: a client configured to send user requests and to receive query result sets corresponding with the user requests, the client including, a client table for displaying a portion of the query result set, and a client cache for storing the query result set, where the client cache includes, a first queue for tracking inflight user requests, the inflight user requests representing a first number of user requests corresponding with a first portion of the query result set, a second queue for tracking blocked user requests, the blocked user requests representing a second number of user requests corresponding with a second portion of the query result set, a third queue for tracking blocked cache user requests, the blocked cache user request representing a third number of user requests corresponding with a third portion of the query result set, and a request result table for storing the query result set from the first queue, the second queue, and the third queue in an ordered and contiguous fashion, the request result table configured to provide the portion of the query result set to the client table in response to the user request.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagrammatic representation of a queue management system for managing query result sets in accordance with embodiments of the present invention;

FIG. 2A is an illustrative representation of a user request in accordance with embodiments of the present invention;

FIG. 2B is an illustrative representation of a query result set in accordance with embodiments of the present invention;

FIG. 3 is an illustrative flowchart of methods for managing a query result set in accordance with embodiments of the present invention;

FIG. 4 is an illustrative flowchart of methods for processing an application server response for an inflight request in accordance with embodiments of the present invention;

FIG. 5 is an illustrative flowchart of methods for processing a blocked queue in accordance with embodiments of the present invention; and

FIG. 6 is an illustrative flowchart of methods for processing a blocked cache queue in accordance with embodiments of the present invention.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks

Referring now to the Figures, the flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Web search engines such as Google and Yahoo allow a user to enter a query and return results. A limited number of results may be displayed one page at a time. Typically, if the result the user is looking for is not available on the displayed page, the user may click a link to display additional pages having additional results. With the introduction of Web 2.0 technologies such as asynchronous JavaScript and XML (AJAX) and asynchronous request management there is no need to keep the outdated paging model for Web applications. Modern JavaScript libraries such as Open Rico and DOJO have implemented rich client technologies for displaying results in a single window with a scroll bar that provides the ability to scroll through all the results without forcing the user to navigate through many pages.

Several challenges arise when implementing rich clients that enable scrolling. One challenge encountered in implementing rich clients arises because a user can freely scroll forward to any position in a result list, which may adversely affect server performance. For example, a user initiating a search may retrieve a first set of results (e.g. results 1 to 20) from a server. If the user immediately scrolls to the last set of results (e.g. results 9980 to 10000) a server may experience performance degradation a) because conventional servers may not be configured to skip forward through sets of results, and b) because conventional servers may be required to re-execute a query to accommodate the scrolling request. The problem is exacerbated if the user then skips backward to the first set of results. As above, conventional servers may not be configured to skip backward through sets of results and conventional servers may be required to re-execute a query. Moreover, the problem is further exacerbated if the user skips forward and backward to intermediate search results, which may result in multiple re-executions of queries. With each re-execution of a query, server resources are further taxed which may result in degradation of service.

Another challenge encountered in such a scheme is that communication ports may be overburdened by server traffic in response to user requests. As may be appreciated, each query that is executed requires some communication traffic. When a server executes multiple queries in response to a user scrolling haphazardly through a query result set, communication ports may be unduly burdened. This may be particularly undesirable in high traffic or low bandwidth networks.

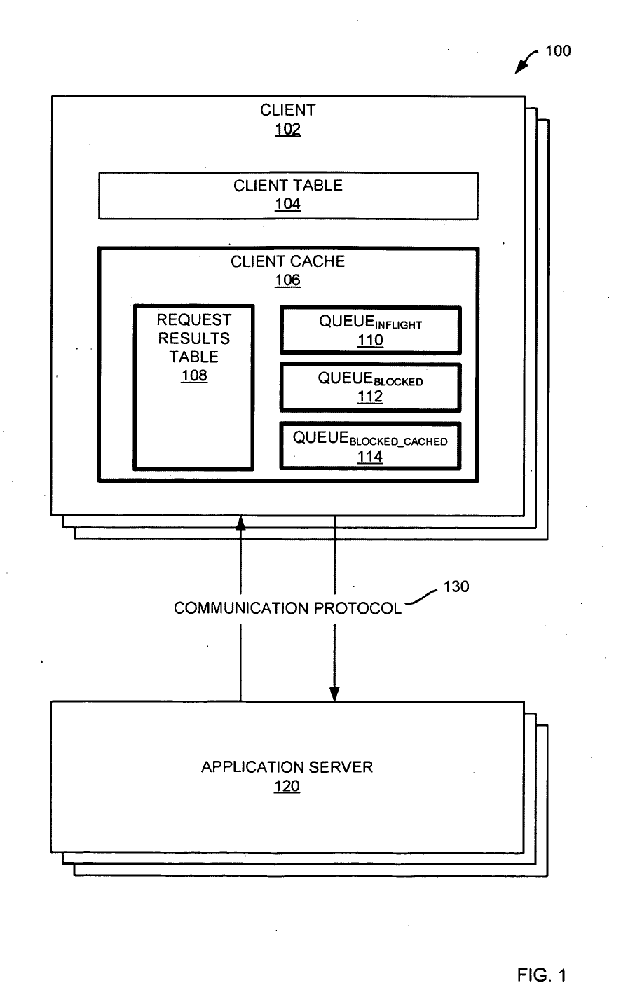

FIG. 1 is a diagrammatic representation of a queue management system 100 for managing query result sets in accordance with embodiments of the present invention. As illustrated, queue management system 100 includes a client 102 and an application server 120. In embodiments, client 102 may be configured to send a query result set to application server 120 and to receive results from application server 120 corresponding with the query result set. In embodiments, clients may include a browser client, a network client, a wireless network client, and a rich client without limitation. Client 102 may be further configured to communicate with application server 120 over communication protocol 130. In embodiments, communication protocols may include HTTP, TCP/IP, a network communication protocol, and a wireless communication protocol without limitation. It may be appreciated that multiple clients and multiple application servers may be enabled in embodiments without departing from the present invention.

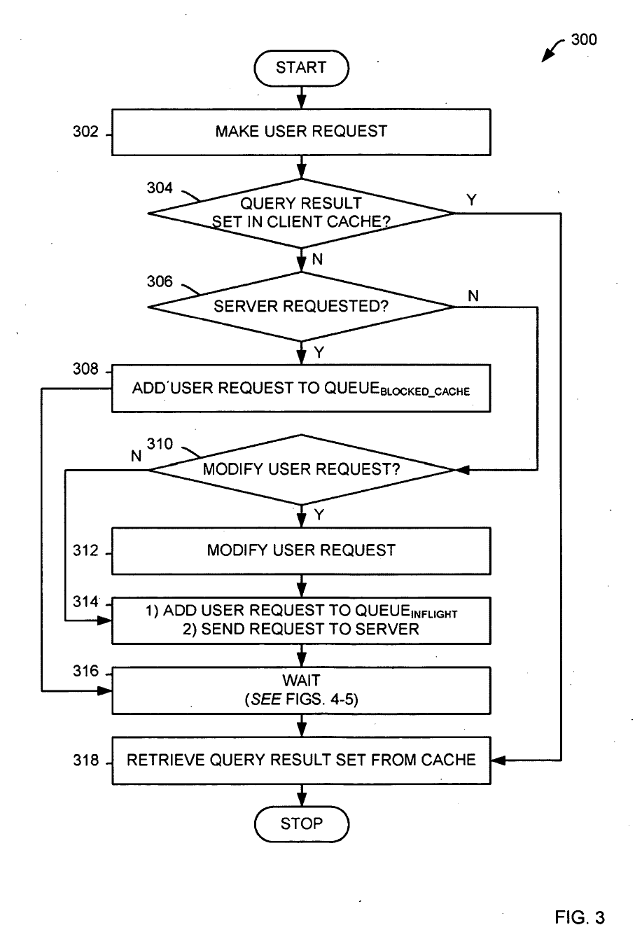

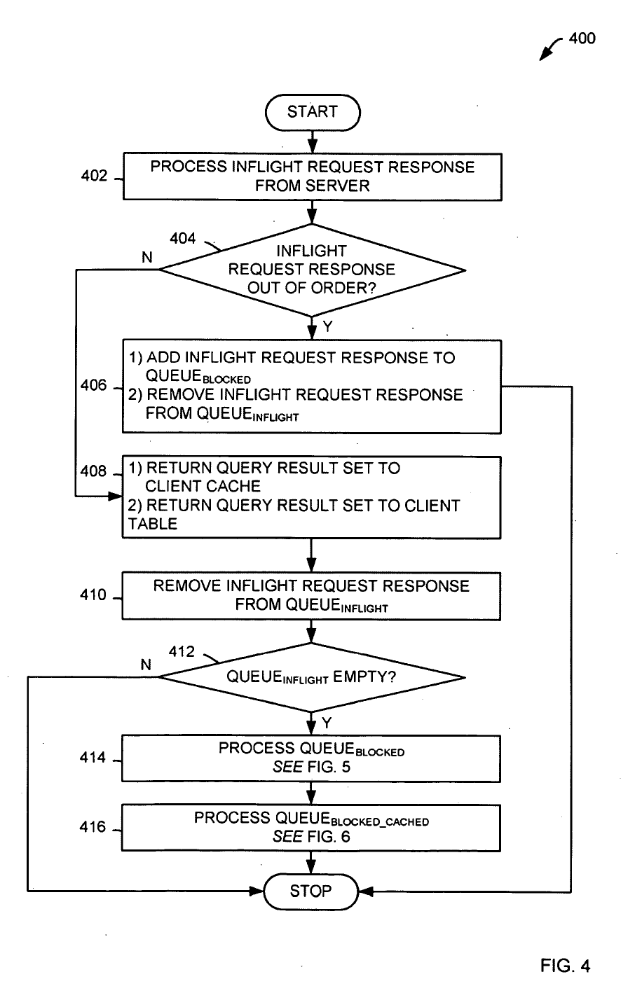

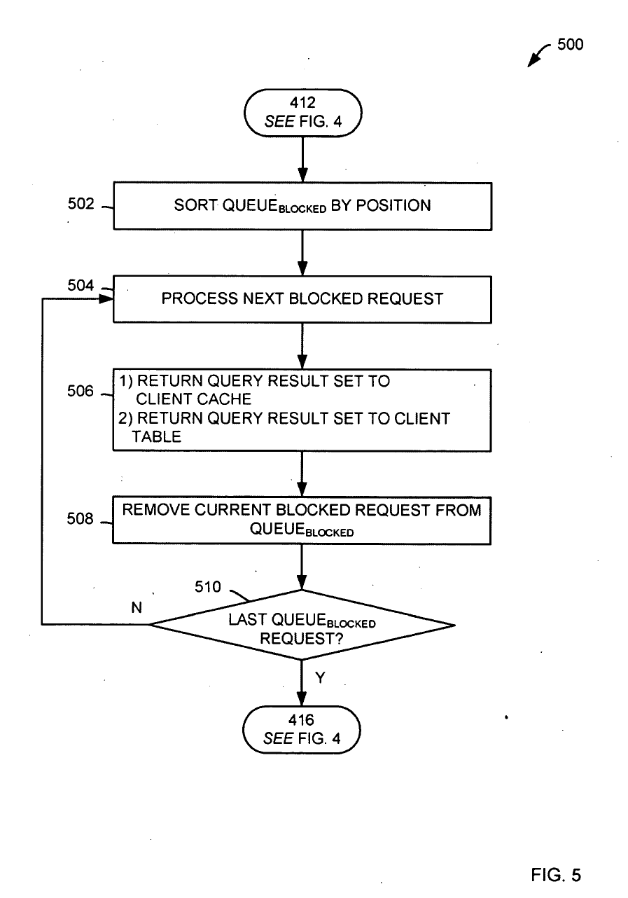

Client 102 may be configured to send user requests to application server 120 and receive handle query result sets from application server 120. As utilized herein, a query result set corresponds with the results of a search. Further, as utilized herein, a user request corresponds with a requested portion of a query result set. Thus, a user may request a portion of a query result set through a user request such as by scrolling. The results of a user request may then be displayed on client table 104. Generally, a client table may be utilized for showing a limited view (or window) of a larger query result set. Users may change views by scrolling through displayed results without being blocked by the UI as in conventional solutions. Client 102 further includes client cache 106. In embodiments, client cache 106 may be configured to store a query result set in an ordered and contiguous fashion returned from application server 120 in request results table 108. In addition, in embodiments, request results table 108 may be configured to provide a portion of the query result set to client table 104. In order to efficiently process user requests, client cache 106 may utilize at least three queues (110, 112, and 114). In embodiments, queue_{inflight} 110 may be configured to track inflight user requests. Inflight user requests correspond with requests made to and currently processed by an application server. Inflight user requests will be discussed in further detail below for FIGS. 3 and 4. Further, in embodiments, queue_{blocked} 112 may be configured to track blocked user requests. Blocked user requests correspond with requests made to application server that require partial results from another currently inflight request to return results back to the client. Blocked user requests will be discussed in further detail below for FIGS. 4 and 5. Still further, in embodiments, queue_{blocked}_{_{—}}_{cached} 114 may be configured to track blocked cache user requests. Blocked cache user requests correspond with requests where all required results are already being fetched by one or more inflight requests. Blocked user requests will be discussed in further detail below for FIG. 3. By utilizing these queues, a query result set may be effectively handled so that user requests do not overly burden server resources.

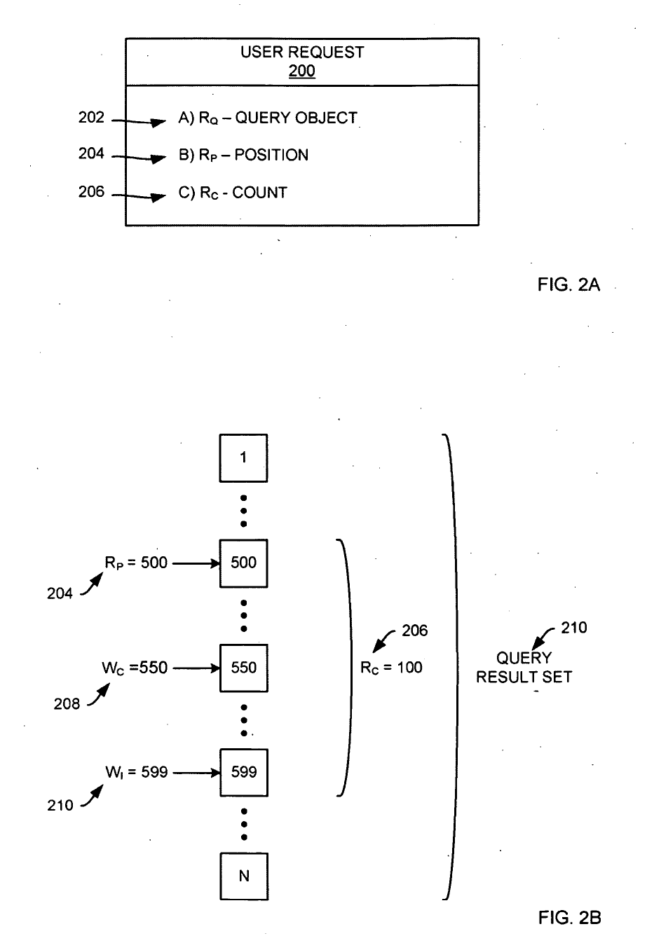

FIG. 2A is an illustrative representation of a user request 200 in accordance with embodiments of the present invention. As illustrated, user request 200 may include at least: query object (R_{Q}) 202, position value (R_{P}) 204, and count (R_{C}) 206. In embodiments, a query object is a representation of a query such as: an SQL query, an XQuery, and an XPath query without limitation. Turning to FIG. 2B, which is an illustrative representation of a query result set 210 in accordance with embodiments of the present invention, when a request to view a portion of a query result set is made, the request may be first defined by R_{P} 204. In this example R_{P}=500. Thus, the first desired result of a user request corresponds with result 500 of the query result set. The number of results requested may be defined by R_{C} 206. In this example, R_{C}=100. Thus, results 500 to 599 may be returned from query result set 210 by this user request. Two additional values may be defined as well. High watermark (W_{I}) 210 corresponds with a highest result requested from a server. In this example W_{I}=599. Additionally, highest result watermark (W_{C}) 208 corresponds with a highest result received from a server and added to cache. In this example W_{C}=550. Watermark values may be utilized in implementing user requests which will be discussed in further detail below.

FIG. 3 is an illustrative flowchart 300 of methods for managing a query result set in accordance with embodiments of the present invention. At a first step 302, the method makes a user request. As noted above, a client table may be utilized for showing a limited view (or window) of a large result set (e.g. a query result set). Users may change views by scrolling through displayed results without being blocked by the UI as in conventional solutions. When a user changes view, a user request from a client table may be generated that corresponds with a requested view change. For example, if a user is viewing results 1 to 20 and scrolls to query results 500 to 600, a user request may be generated requesting results 500 to 600. After a user request is made at a step 302, the method determines whether the query result set is all ready resident in client cache at a step 304. If the method determines at a step 304 that the query result set is already resident in client cache, the method continues to a step 318 to retrieve the query result set from client cache for viewing on a client table, whereupon the method ends. The following example is provided for clarity's sake in further understanding embodiments of the invention and should not be construed as limiting in any way.

### EXAMPLE 1

a) An initial condition of a request results table is W_{I}=100 and W_{C}=100. That is, the highest result requested from a server (i.e. W_{I}) is 100 and the highest result received from a server (i.e. W_{C}) is 100.

b) A user request for results 40 to 50 is made where R_{P}=40 and R_{C}=11.

Because the user request is resident in cache as indicated by W_{C}, results 40 to 50 may be retrieved from cache (see a step 318).

Returning to FIG. 3, if the method determines at a step 304 that the query result set is not resident in client cache, the method then determines whether the user request corresponding with a query result set has been already been requested from a server at a step 306. If the method determines at a step 306 that the user request has already been requested, the method continues to a step 308 to add the user request to a blocked cache queue. The following modifying example is provided for clarity's sake in further understanding embodiments of the invention and should not be construed as limiting in any way.

### EXAMPLE 2

a) An initial condition of a request results table is W_{I}=500 and W_{C}=100. That is, the highest result requested from a server (i.e. W_{I}) is 500 and the highest result received from a server and cached in client cache (i.e. W_{C}) is 100.

b) A user request for results 50 to 250 is made where R_{P}=50 and R_{C}=201.

Blocked Cache Queue—In this example, since a portion of the query result set is being retrieved, but not yet fully received from server, the user request is moved to blocked cache queue to avoid multiple user requests to a server for a query result set that is already being processed. This is true even though at least some of the results may already be in client cache. As will be discussed subsequently, once inflight queue requests are processed, blocked cache queue requests may be displayed and removed from blocked cache queue.

The method continues to a step 316 to wait. Waiting, in embodiments, may include additional steps which will be discussed in further detail below for FIGS. 4 and 5. If the method determines at a step 306 that all or part of the user requests have not already been requested, the method determines whether to modify the user request at a step 310. If the method determines at a step 310 to modify a user request, the method continues to a step 312 to modify the user request. In embodiments, optionally modifying a user request may be useful for providing for contiguous client cache. The following example is provided for clarity's sake in further understanding embodiments of the invention and should not be construed as limiting in any way.

### EXAMPLE 3

a) An initial condition of a request results table is W_{I}=100 and W_{C}=100. That is, the highest result requested from a server (i.e. W_{I}) is 100 and the highest result received from a server (i.e. W_{C}) is 100.

b) A user request for results 500 to 600 is made where R_{P}=500 and R_{C}=101.

Modification—In embodiments, modification may result in R_{P}=101 and R_{C}=499 in accordance with the following formulas:

R_{P}(modified)=W_{I}+1=101

R_{C}(modified)=R_{P}+R_{C}−W_{I}−1=499; and

W_{I}(modified)=R_{P}+R_{C}−1=599.

As may be appreciated, the method modifies the user request to include otherwise non-contiguous results. Thus, if a user scrolls backward, a re-execution of a query may be avoided.

Returning to FIG. 3, the method then adds the user request to an inflight queue at a step 314. Returning to a step 310, if the method determines not to modify a user request, the method adds the user request to an inflight queue and sends the user request to a server at a next step 314. The method continues to a step 316 to wait. Waiting, in embodiments, may include additional steps which will be discussed in further detail below for FIGS. 4 and 5. The method continues to a step 304 to determine whether the query result set is in a client cache.

As utilized herein, the terms queue_{inflight} and inflight queue are synonymous. Further, the terms queue_{blocked} and blocked queue are synonymous. Still further, the terms queue_{blocked}_{_{—}}_{cache} and blocked cache queue are synonymous. Furthermore, a user request that is moved to an inflight queue is denoted an inflight queue request; a user request that is moved to a blocked queue is denoted a blocked queue request; and a user request that is moved to a blocked cache queue is denoted a blocked cache queue request.

FIG. 4. is an illustrative flowchart 400 of methods for processing a server response for an inflight request in accordance with embodiments of the present invention. Embodiments provided may include any number of inflight user requests, which may be ordered when they are returned from the server to avoid non-contiguous caching and to avoid unnecessary re-execution of queries. At a first step 402, the method processes an inflight request response. An inflight request is a user request that has been added to an inflight queue in accordance with embodiments described herein. An inflight request response is a query result set returned from a server in response to an inflight request. At a next step 404, the method determines whether the response for the inflight request response is out of order. That is, the method examines whether the inflight request response is sequential with respect to any other inflight queue requests currently being processed at the server, or currently any request being blocked by inflight request in blocked queue. The following example is provided for clarity's sake in further understanding embodiments of the invention and should not be construed as limiting in any way.

### EXAMPLE 4

a) Initial conditions are as follows:
W_{C}=100 and W_{I}=100;
R_{P1}=500 and R_{C1}=100;
R_{P2}=600 and R_{C2}=100;
R_{P3}=650 and R_{C3}=100;
R_{P4}=450 and R_{C4}=100; and
R_{P5}=0 and R_{C5}=100.

b) Conditions after utilizing methods described in FIG. 3:
W_{C}=100 and W_{I}=749;
R_{P1}=101 and R_{C1}=499→added to inflight queue;
R_{P2}=600 and R_{C2}=100→added to inflight queue;
R_{P3}=700 and R_{C3}=50→added to inflight queue;
R_{P4}=450 and R_{C4}=100→added to blocked cache queue; and
R_{P5}=0 and R_{C5}=100→returned from cache.

If R₂ is the first inflight request response returned by the server, then the value of R_{P2} is compared with all other inflight R_{P} values (i.e. 101, 600, and 700). As may be seen, R_{P2} is out of order with respect to R_{P1}, so the method adds R₂ to blocked queue and removes R₂ from the inflight queue (see a step 406). Thus, if the method determines at a step 404 that the inflight request response is out of order, the method continues to a step 406 to add the inflight request response to blocked queue and remove the inflight request response from inflight queue whereupon the method ends.

c) Conditions after R₂ is examined utilizing methods described herein:
W_{C}=100 and W_{I}=749;
R_{P1}=101 and R_{C1}=499→added to inflight queue;
R_{P2}=600 and R_{C2}=100→added to blocked queue;
R_{P3}=700 and R_{C3}=50→added to inflight queue;
R_{P4}=450 and R_{C4}=100→added to blocked cache queue; and
R_{P5}=0 and R_{C5}=100→returned from cache.

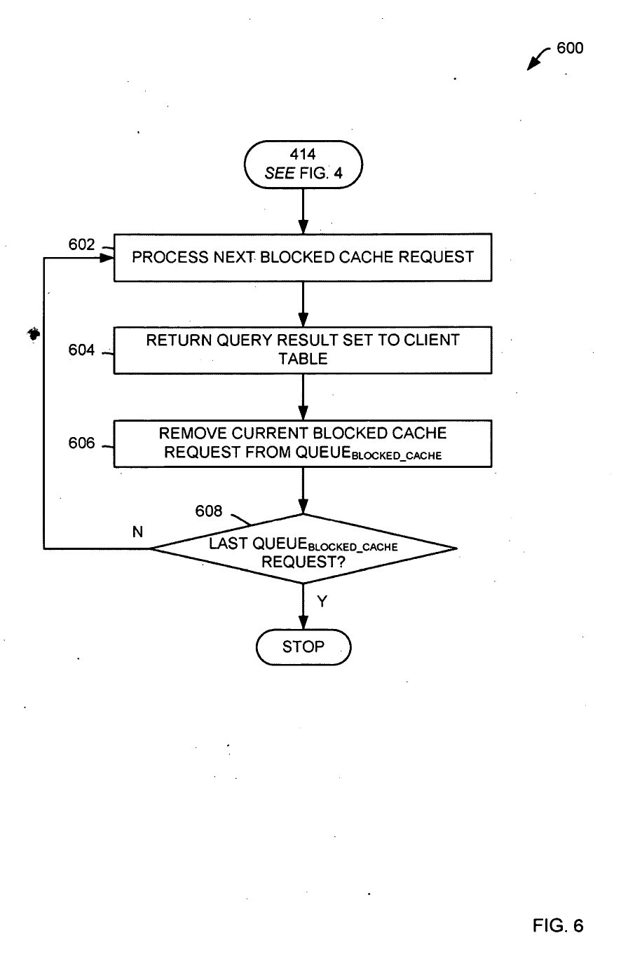

Returning to a step 404, if the method determines that the inflight request response is not out of order, the method continues to a step 408 to return the inflight request response (or query result set) to a client cache and to return the query result set to a client table, whereupon the method continues to a step 410 to remove the inflight request response from the inflight queue. The method then determines whether the inflight queue request is empty at a step 412. If the method determines at a step 412 that the inflight queue is not empty, the method ends. In some embodiments, the method returns to a wait state. If the method determines at a step 412, that the inflight queue is empty, the method proceeds to a step 414 to process blocked queue, which step will be discussed in further detail below for FIG. 5. The method then continues to a step 416 to process blocked cache queue, which step will be discussed in further detail below for FIG. 6.

FIG. 5 is an illustrative flowchart 500 of methods for processing a blocked queue in accordance with embodiments of the present invention. In particular, flowchart 500 is a further representation of a step 414 (FIG. 4). At a first step 502, the method sorts a blocked queue by a position value. At a next step 504, the method processes a next blocked request, which, by convention, becomes the current blocked request. A blocked request is a user request that has been added to a blocked queue in accordance with embodiments described herein. At a next step 506, the method returns the query result set corresponding with the current blocked request from a server to a client cache and returns the query result set to a client table, whereupon the method continues to a step 508 to remove the current blocked request from the blocked queue. Observe that when returning a query result set to the client table, portions of a query result set may have been retrieved by one or more previous requests, and portions of the query result set are retrieved from this request response. The method then determines whether the last blocked request has been processed at a step 510. If the method determines at a step 510 that the last blocked request has not been processed, the method continues to a step 504 to process a next blocked request. If the method determines at a step 510, that the last blocked request has been processed, the returns to a step 416.

FIG. 6 is an illustrative flowchart 600 of methods for processing a blocked cache queue in accordance with embodiments of the present invention. In particular, flowchart 600 is a further representation of a step 416 (FIG. 4). At a first step 602, the method processes a next blocked cache request, which, by convention, becomes the current blocked cache request. A blocked cache request is a user request that has been added to a blocked cache queue in accordance with embodiments described herein. At a next step 604, the method query result set corresponding with the current blocked cache request to a client table from cache, whereupon the method continues to a step 606 to remove the current blocked cache request from the blocked cache queue. The method then determines whether the last blocked cache request has been processed at a step 608. If the method determines at a step 608 that the last blocked cache request has not been processed, the method continues to a step 602 to process a next blocked cache request. If the method determines at a step 608, that the last blocked cache request has been processed, the method ends.

d) Conditions after R_{I} is examined utilizing methods described herein:
W_{C}=599 and W_{I}=749;
R_{P3}=700 and R_{C3}=50→added to inflight queue;
R_{P4}=450 and R_{C4}=100→added to blocked cache queue; and
R_{P5}=0 and R_{C5}=100→returned from cache.

e) Conditions after R₃ is examined utilizing methods described herein:
W_{C}=599 and W_{I}=749
R_{P3}=700 and R_{C3}=50→added to blocked queue since it is blocked by R_{P2}
R_{P4}=450 and R_{C4}=100→added to blocked cache queue; and
R_{P5}=0 and R_{C5}=100→returned from cache.

Since inflight queue is empty, requests in blocked queue are handled according to FIG. 4.

f) Conditions after R_{P2} is examined following the steps in FIG. 4.
W_{C}=699 and W_{I}=749

g) Conditions after R_{P3} is examined following the steps in FIG. 4.
W_{C}=749 and W_{I}=749

h) Conditions after R_{P4} is examined following the steps in FIG. 5.
W_{C}=749 and W_{I}=749

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A method for managing a query result set in response to a search, the method comprising:
generating a user request corresponding with a portion of the query result set:
responsive to the portion of the query result set being resident on a client cache, returning the portion of the query result set corresponding with the user request to a client table;
responsive to the user request not having been sent to an application server, adding the user request to an inflight queue, sending the user request to the application server, receiving the query result set from the application server, returning the portion of the query result set corresponding with the user request to the client cache, and returning the portion of the query result set corresponding with the user request to the client table; and
responsive to the user request having been sent to the application server, adding the user request to a blocked cache queue.

2. The method of claim 1, further comprising:
responsive to the user request representing a non-contiguous portion of the query result set resident on the client cache, modifying the user request to include the non-contiguous portion of the query result set such that the client cache is contiguous; and
responsive to the user request representing an overlapping portion of the query result set resident on the client cache, modifying the user request to omit the overlapping portion of the query result set.

3. The method of claim 1, further comprising:
providing an inflight request response, the inflight request response corresponding with the user request added to the inflight queue;
responsive to the inflight request response being out of order with respect to the query result set, adding the inflight request response to a blocked queue and removing the inflight request response from the inflight queue;
responsive to the inflight request response being in order with respect to the query result set, returning the portion of the query result set corresponding with the user request to the client cache and to the client table, and removing the inflight request response from the inflight queue; and
processing the blocked queue; and
processing the blocked cache queue.

4. The method of claim 3, wherein the processing the blocked queue comprises:
sorting the blocked queue with respect to a position value;
providing a next blocked queue request, the next blocked request corresponding with the inflight request response added to the blocked queue;
returning the portion of the query result set corresponding with the user request to the client cache and client table; and
removing the next blocked queue request from the blocked queue.

5. The method of claim 3 wherein the processing the blocked cache queue comprises:
providing a next blocked cache queue request, the next blocked request corresponding with the user request added to the blocked cache queue;
returning the portion of the query result set corresponding with the user request to the client cache and client table; and
removing the next blocked cache queue request from the blocked cache queue.

6. The method of claim 1, wherein the user request comprises:
a query object for representing the query;
a position value for representing a position in the query result set; and
a count for representing a number of requested results.

7. The method of claim 6, wherein the query object is selected from the group consisting of an SQL query, an XQuery, and an XPath query.

8. The method of claim 1, wherein the client is selected from the group consisting of: a browser client, a network client, a wireless network client, and a rich client.

9. A computer program product for managing a query result set in response to a search, the computer program product comprising:
a computer readable medium;
first program instructions for generating a user request corresponding with a portion of the query result set;
responsive to the portion of the query result set being resident on a client cache, second program instructions for returning the portion of the query result set corresponding with the user request to a client table;
responsive to the user request not having been sent to an application server, third program instructions for adding the user request to an inflight queue, sending the user request to the application server, returning the portion of the query result set corresponding with the user request to the client cache, and returning the portion of the query result set corresponding with the user request to the client table; and
responsive to the user request having been sent to the application server, fourth program instructions for adding the user request to a blocked cache queue, wherein the first, second, third, and fourth program instructions are stored on the computer readable media.

10. The computer program product of claim 9, further comprising:
responsive to the user request representing a non-contiguous portion of the query result set resident on the client cache, fifth program instructions for modifying the user request to include the non-contiguous portion of the query result set such that the client cache is contiguous; and
responsive to the user request representing an overlapping portion of the query result set resident on the client cache, sixth program instructions for modifying the user request to omit the overlapping portion of the query result set, wherein the fifth and sixth program instructions are stored on the computer readable media.

11. The computer program product of claim 9, further comprising:
seventh program instructions for providing an inflight request response, the inflight request response corresponding with the user request added to the inflight queue;
responsive to the inflight request response being out of order with respect to the query result set, eighth program instructions for adding the inflight request response to a blocked queue and removing the inflight request response from the inflight queue;
responsive to the inflight request response being in order with respect to the query result set, ninth program instructions for returning the portion of the query result set corresponding with the user request to the client cache and to the client table, and removing the inflight request response from the inflight queue;
tenth program instructions for processing the blocked queue; and
eleventh program instructions for processing the blocked cache queue, wherein the seventh, eighth, ninth, tenth, and eleventh program instructions are stored on the computer readable media.

12. The computer program product of claim 11, wherein the tenth program instructions for processing the blocked queue comprises:
twelfth program instructions for sorting the blocked queue with respect to a position value;
thirteenth program instructions for providing a next blocked queue request, the next blocked request corresponding with the inflight request response added to the blocked queue;
fourteenth program instructions for returning the portion of the query result set corresponding with the user request to the client cache and client table; and
fifteenth program instructions for removing the next blocked queue request from the blocked queue, wherein the twelfth, thirteenth, fourteenth, and fifteenth program instructions are stored on the computer readable media.

13. The computer program product of claim 11 wherein the eleventh program instructions for processing the blocked cache queue comprises:
sixteenth program instructions for providing a next blocked cache queue request, the next blocked request corresponding with the user request added to the blocked cache queue;
seventeenth program instructions for returning the portion of the query result set corresponding with the user request to the client cache and client table; and
eighteenth program instructions for removing the next blocked cache queue request from the blocked cache queue, wherein the sixteenth, seventeenth, and eighteenth program instructions are stored on the computer readable media.

14. The computer program product of claim 9, wherein the user request comprises:
a query object for representing the query;
a position value for representing a position in the query result set; and
a count for representing a number of requested results.

15. The computer program product of claim 14, wherein the query object is selected from the group consisting of: an SQL query, an XQuery, and an XPath query.

16. The computer program product of claim 9, wherein the client is selected from the group consisting of: a browser client, a network client, a wireless network client, and a rich client.

17. A system for managing a query result set, the system comprising:
a client configured to send a plurality of user requests and to receive the query result set corresponding with the plurality of user requests, the client comprising,
a client table for displaying a portion of the query result set, and
a client cache for storing the query result set, wherein the client cache comprises,
a first queue for tracking plurality of inflight user requests the plurality of inflight user requests representing a first plurality of user requests corresponding with a first portion of the query result set,
a second queue for tracking a plurality of blocked user requests, the plurality of blocked user requests representing a second plurality of user requests corresponding with a second portion of the query result set,
a third queue for tracking a plurality of blocked cache user requests, the plurality of blocked cache user requests representing a third plurality of user requests corresponding with a third portion of the query result set, and
a request result table for storing the query result set from the first queue, the second queue, and the third queue in an ordered and, contiguous fashion, the request result table configured to provide the portion of the query result set to the client table in response to the user request.

18. The system of claim 17, further comprising:
a communication protocol for providing communication between the application server and the client.

19. The system of claim 17, wherein each of the inflight user request, the blocked user request, and the blocked cache user request comprise:
a query object for representing the query;
a position value for representing a position in the query result set; and
a count for representing a number of requested results.

20. The system of claim 19, wherein the query object is selected from the group consisting of an SQL query, an XQuery, and an XPath query.

21. The system of claim 17, wherein the client is selected from the group consisting of: a browser client, a network client, a wireless network client, and a rich client.

22. The system of claim 17, wherein the communication protocol is selected from the group consisting of: HTTP, TCP/IP, a network communication protocol, and a wireless communication protocol.
